(19) United States
(12) Patent Application Publication
(10) Pub. No.: US 2014/0365006 A1
(43) Pub. Date: Dec. 11, 2014

(54) Visual Datum Reference Tool

(71) Applicant: Matthew E. Trompeter, Macomb, MI (US)

(72) Inventor: Matthew E. Trompeter, Macomb, MI (US)

(21) Appl. No.: 13/912,501

(22) Filed: Jun. 7, 2013

(51) Int. Cl. B25J 9/16

(52) U.S. Cl. CPC B25J 9/1692
USPC 700/254

(57) ABSTRACT

The visual datum reference tool calibration method includes a work object. The work object emits a pair of beam-projecting lasers acting as a crosshair, intersecting at a tool center point. The visual datum reference tool calibration method provides a calibration method which is simpler, which involves a lower investment cost, which entails lower operating costs than the prior art, and can be used for different robot tools on a shop floor without having to perform a recalibration for each robot tool. The visual datum reference tool is applicable to multiple robotic processes, including but not limited to, spot welders, material handlers, and MIG welders, assembly, cutting, painting and coating, and polishing and finishing.

This application is related to and claims priority to U.S. Provisional Application No. 61/689,643, entitled “Visual Datum Reference Tool”, Trompeter, filed on Jun. 11, 2012; U.S. Provisional Application No. 61/848,482, entitled “Automatic Robotic Tool Finder”, Trompeter, filed on Jan. 4, 2013; and U.S. Provisional Application No. 61/849,261, “Automatic and Manual Robotic Tool Finders”, Trompeter, filed on Jan. 23, 2013.

### FIELD OF USE

The present invention relates to a visual datum reference tool for use with an industrial robot and, more particularly, to a calibration method for the industrial robot provided with an imaging device of a visual sensor for detecting a working tool and a working position.

### BACKGROUND OF THE INVENTION

The sales of industrial robots that has been driven by the automotive industry, is now moving into tasks as diverse as cleaning sewers, detecting bombs, and performing intricate surgery. The number of units sold increased to 120,000 units in 2010, twice the number as the previous year, with automotive, metal and electronics industries driving the growth.

Prior approaches to calibrating robots use measuring devices that either measures the inaccuracies of the robots after the robot is built or devices which measure work a pieces position relative to the robots position prior to OLP's. Prior art methods involve expensive equipment and specialized users and takes longer.
U.S. Pat. No. 7,979,159 (Fixell) discloses an invention which relates to a method and a system for determining the relation between a local coordinate system located in the working range of an industrial robot and a robot coordinate system. The method includes attaching a first calibration object in a fixed relation to the robot and determining the position of the first calibration object in relation to the robot. Then, locating at least three second calibration objects in the working range of the robot, a reference position for each of the second calibration objects in the local coordinate system can be determined by moving the robot until the first calibration object is in mechanical contact with each second calibration object. By reading the position of the robot when the calibration objects are in mechanical contact the relation between the local coordinate system and the robot coordinate system can be calculated.
U.S. Pat. No. 7,945,349 (Svensson, et. al.) discloses an invention which relates to a method and a system for facilitating calibration of a robot cell including one or more objects and an industrial robot performing work in connection to the objects. The robot cell is programmed by means of an off-line programming tool including a graphical component for generating 2D or 3D graphics based on graphical models of the objects. The system comprises a computer unit located at the off-line programming site and configured to store a sequence of calibration points for each of the objects, and to generate a sequence of images including graphical representations of the objects to be calibrated and the calibration points in relation to the objects.
U.S. Pat. No. 7,756,608 (Brogardh) discloses a method for calibration of an industrial robot including a plurality of movable links and a plurality of actuators effecting movement of the links and thereby of the robot. The method includes mounting a measuring tip on or in the vicinity of the robot, moving the robot such that the measuring tip is in contact with a plurality of measuring points on the surface of at least one geometrical structure on or in the vicinity of the robot, reading and storing the positions of the actuators for each measuring point, and estimating a plurality of kinematic parameters for the robot based on a geometrical model of the geometrical structure, a kinematic model of the robot, and the stored positions of the actuators for the measuring points.

Prior approaches to calibrating robots use measuring devices that either measure the inaccuracies of the robots after the robot is built or devices which measure work pieces positions relative to the position of the robot prior to off line programs. Prior art methods also involve expensive equipment that require extensive training and are difficult to use.

Applicant is also the inventor of PCT Application No. PCT/US2012/00140 entitled “Robotic Work Object Cell Calibration Device, System, and Method” (Trompeter), filed on Mar. 14, 2012. The disclosure of this PCT Application is hereby incorporated by reference into this specification in its entirety in order to more fully describe the state of the art. However, said work object calibration device obstructs one of said laser beams preventing said device from serving as a visual datum reference tool. What is needed is a visual datum reference tool that does not obstruct either said first or said second laser beam.

There is no need for additional computers or software to determine the accuracy of the robot or location of robot's peripheral equipment.

What are needed is a visual datum reference tool and method that use existing body in white applications (BIW), personnel, computers, software and ways of communicating information amongst the trades that requires little or no retraining, and is relatively easy to operate to implement.

What are needed is a visual datum reference tool and method that are cost and time effective over the prior art in applications where absolute accurate of the robots is not necessary. Examples of the foregoing are body in white applications (BIW), resistance welding, material handling, metal inert gas (MIG) welding, assembling, cutting, painting and coating, and polishing and finishing.

### SUMMARY OF THE INVENTION

The visual datum reference tool of the present invention addresses these objectives and these needs.

The technology enables the user to visually see a robotic reference frame (a frame in space that is relative to an industrial robot) that is otherwise abstract and cannot be seen. Enabling the user to visually see the robotic reference frame on the shop floor will enable the user to adjust the robotic frame to the shop floor environment and, thereby, correct a robotic path or off line program (OLP) to obtain accuracy.

The visual datum reference tool of the present invention includes two (2) laser beams positioned onto a work piece or tool, at a known location (a numerical control block or NAAMS mounting pattern) with the two lasers intersecting at essentially a 90° angle and continuing to project outward. The tool center point (TCP) of the robot defines the correct location of the robotic reference frame. To accomplish this, the robot TCP will record a first point at the intersection of the two (2) laser beams. A second point is then recorded along the axis of the first laser beam. A third point is then recorded along the axis of the second laser beam. Once all three (3) points are known, the robotic reference frame is generated. The robotic reference frame is then used to adjust the angular position of the robot tool, which can involve adjusting either roll and yaw, roll and pitch, yaw and pitch, or roll yaw and pitch of said robot tool. This method is applicable for all robotic processes, including but not limited to, spot welders, material handlers, and MIG welders, assembly, cutting, painting and coating, and polishing and finishing.

For a complete understanding of the visual datum reference tool and calibration method of the present invention, reference is made to the following summary of the invention detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1A depicts a first perspective view of the preferred embodiment of the visual datum reference tool of the present invention, the visual datum reference tool having two beam-projecting lasers being used for aligning the tool center point with a calibration device.

FIG. 1B depicts a second perspective view of the preferred embodiment of the visual datum reference tool of FIG. 1A.

FIG. 1C depicts a third perspective view of the preferred embodiment of the visual datum reference tool of FIG. 1A mounted on an NC block or a NAAMS mounting.

FIG. 2 depicts the visual datum reference tool of FIG. 1A positioned on a fixture, with the robot being aligned to the tool center point of the visual datum reference tool.

FIG. 3 depicts the visual datum reference tool of FIG. 1A positioned on the fixture as shown in FIG. 2, with the robot being aligned to a point in space along the x-axis of the first laser beam projected from the visual datum reference tool.

FIG. 4 depicts the visual datum reference tool of FIG. 1A positioned on the fixture as shown in FIG. 2, with the robot being aligned to a point in space along the y-axis of the second laser beam projected from the visual datum reference tool.

FIG. 5 depicts a perspective view of a second preferred embodiment of the visual datum reference tool for use with the manual and automatic robot work finder calibration systems and methods of the present invention, the visual datum reference tool having two beam-projecting lasers being used for aligning the tool center point with a calibration device.

FIG. 6 depicts a perspective view of the visual datum reference tool of FIG. 5 positioned on a fixture, with the robot being aligned to the tool center point of the visual datum reference tool.

FIG. 7 depicts a perspective view of the visual datum reference tool of FIG. 5 positioned on the fixture as shown in FIG. 6, with the robot being aligned to a point in space along the x-axis of the first laser beam projected from the visual datum reference tool.

FIG. 8 depicts a perspective view of the visual datum reference tool of FIG. 5 positioned on the fixture as shown FIG. 6, with the robot being aligned to a point in space along the y-axis of the second laser beam projected from the visual datum reference tool.

FIG. 9 depicts a perspective view of a third preferred embodiment of the visual datum reference tool for use with the manual and automatic robot work finder calibration systems and methods of the present invention, the visual datum reference tool having two beam-projecting lasers being used for aligning the tool center point with a calibration device.

### DETAILED DESCRIPTION OF THE PREFERRED EMBODIMENTS

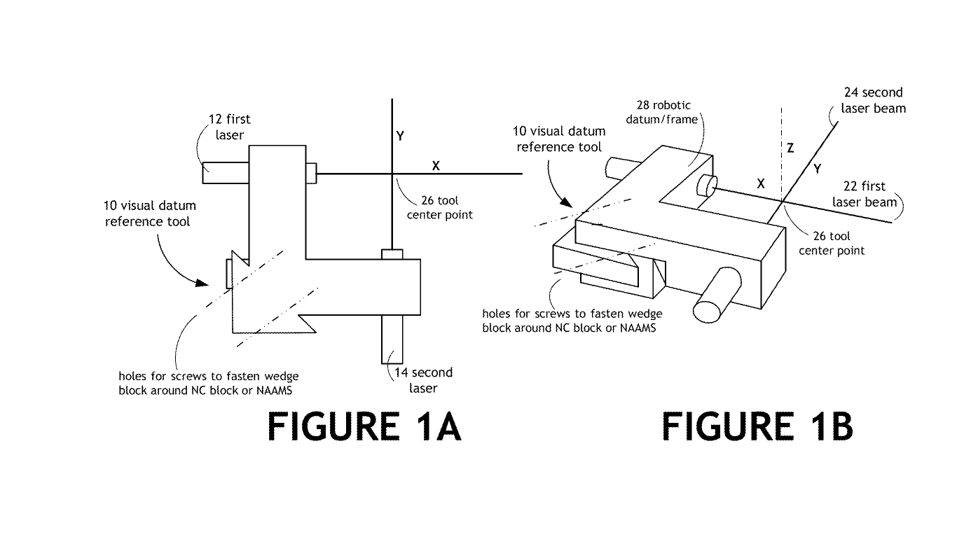

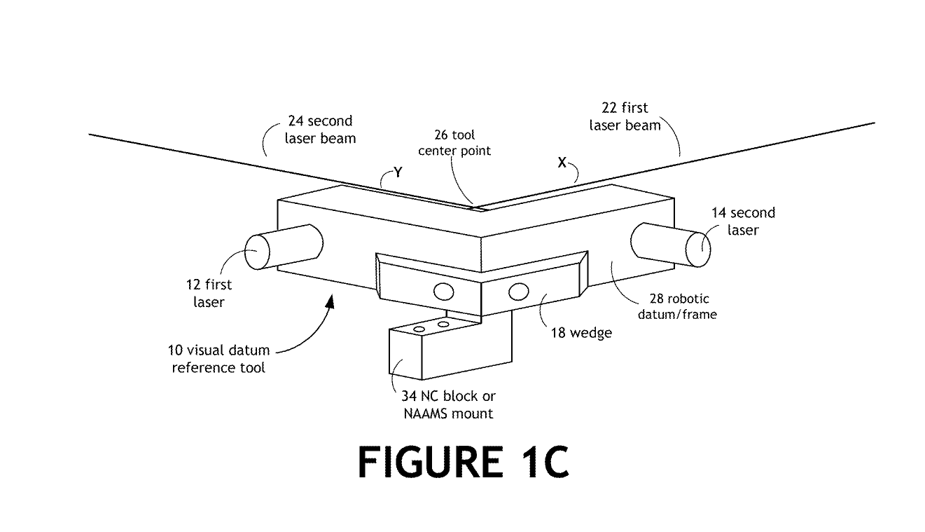

Referring now to the drawings, FIGS. 1A, 1B, and 1C depict the preferred embodiments of the visual datum reference tool [10] of the present invention. The visual datum reference tool [10] preferably has two lasers [12 and 14] securely mounted therein, each laser emitting a laser beam [22 and 24, respectively] therefrom. The lasers are preferably mounted in the robotic datum/frame [28] of the visual datum reference tool [10] so that the laser beams [22 and 24] intersect each other at essentially right angles relative to each other. The two laser beams [22 and 24] are used for aligning the tool center point [26] with a calibration device on a robot tool [20].

The technology enables the user to visually see a robotic reference frame [35] (a frame in space that is relative to an industrial robot) that is otherwise abstract and cannot be seen. Enabling the user to visually see the robotic reference frame [35] on the shop floor will enable the user to adjust the robotic reference frame [35] to the shop floor environment and, thereby, correct a robotic path or off line program (OLP) to obtain accuracy.

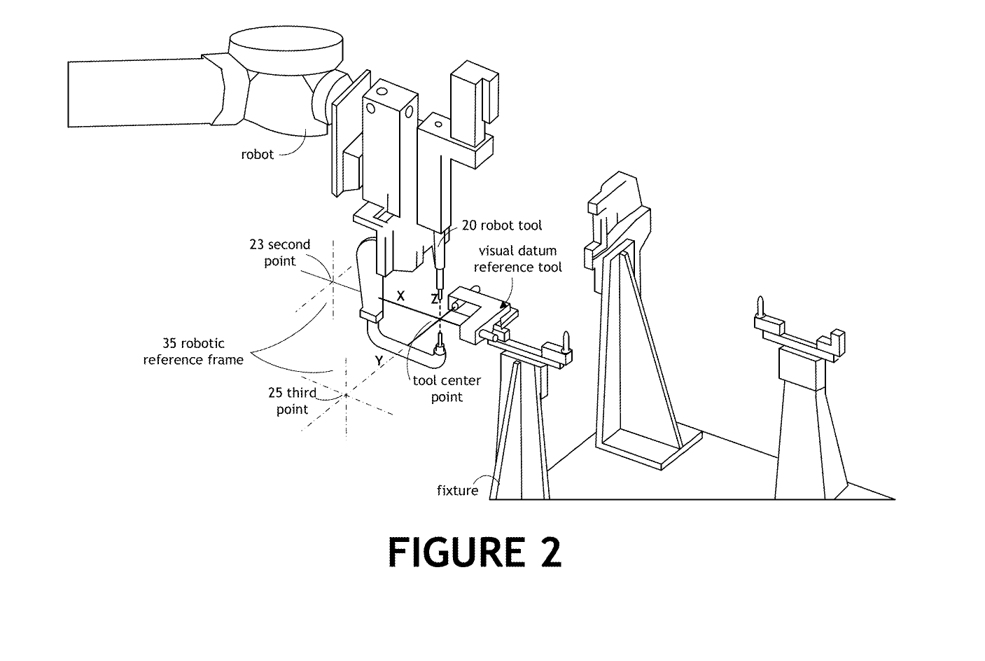

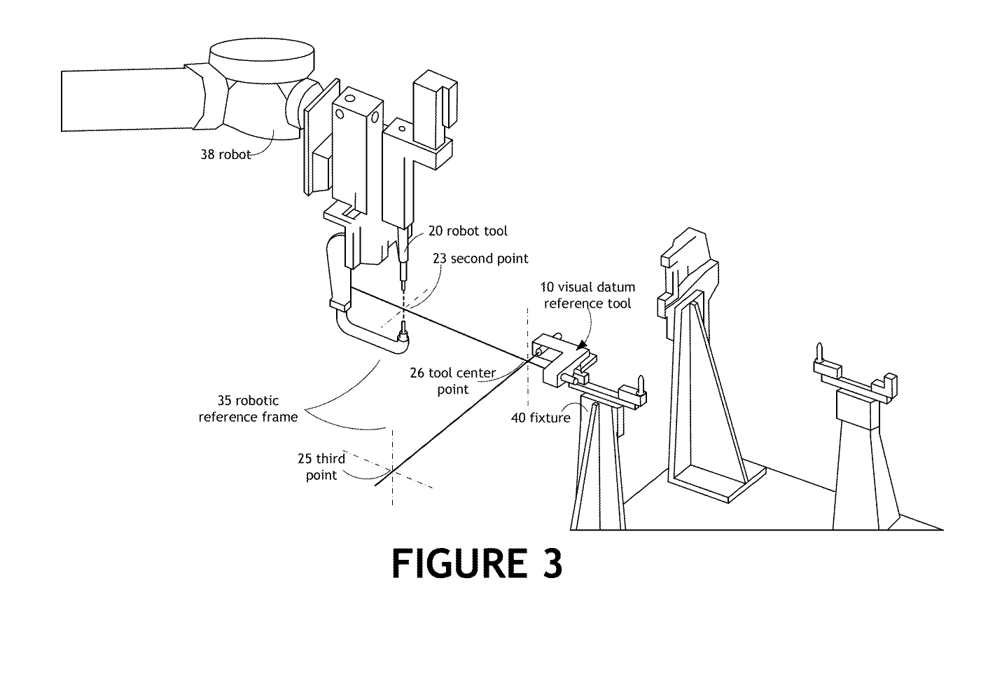

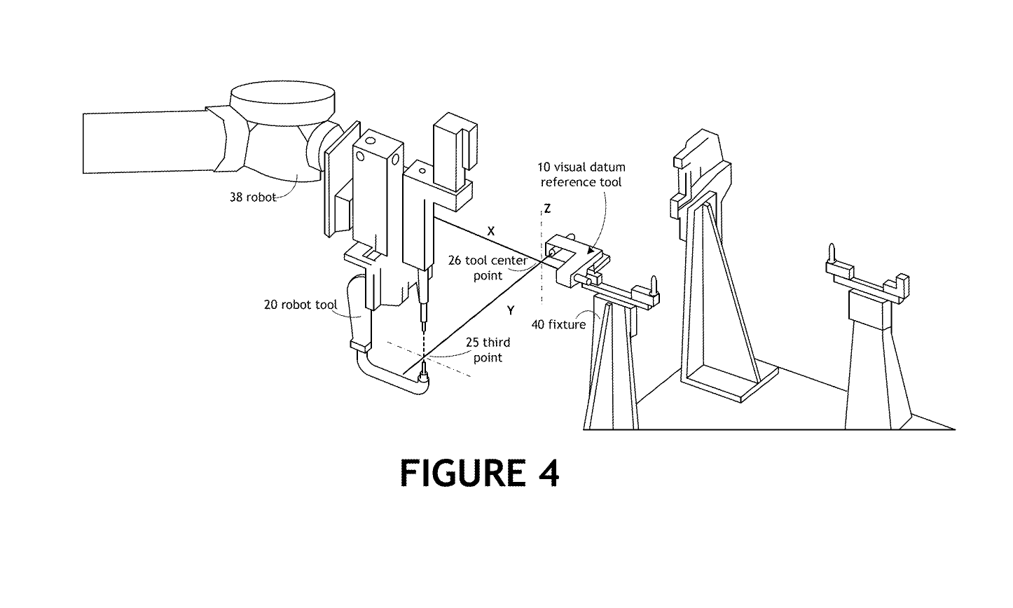

The visual datum reference tool of the present invention [10] includes two (2) laser beams positioned onto a work piece or tool, at a known location with the two laser beams [22 and 24] intersecting at essentially a 90° angle and continuing to project outward. The mounting is preferably a numerical control block or a NAAMS mounting pattern [34]. The tool center point [26] of the robot defines the correct location of the robotic reference frame [35]. To accomplish this, the robot will record a first point [26] at the intersection of the two (2) laser beams (see FIG. 2). A second point [23] is then selected along the axis of the first laser beam [22] (see FIG. 3). A third point [25] is then selected along the axis of the second laser beam [24] (see FIG. 4).

In other words, the robotic reference frame [35] is defined by the two intersecting laser beams [22] and 24]. Once all three (3) points [22, 24, and 26] are known, the robotic reference frame [35] is generated. The robotic reference frame is then used to adjust the angular position of the robot tool [20], which can involve adjusting either roll and yaw, roll and pitch, yaw and pitch, or roll yaw and pitch of said robot tool [20]. This method is applicable for all robotic processes, including but not limited to, spot welders, material handlers, and MIG welders, assembly, cutting, painting and coating, and polishing and finishing.

Using CAD simulation software, the CAD user selects a position on the tool that is best suited to avoid crashes with other tooling and for ease of access for the robot or end-of-arm tooling. The offline programs are then downloaded relative to the visual datum reference tool [10]. The visual datum reference tool [10] is then placed onto the tool or work piece in the position that is defined by the CAD user on the shop floor. The robot technician then manipulates the tool center point [26] of the robot tool [20] into the device and aligns it to the laser beams to obtain the difference between the CAD world and shop floor. This difference is then entered into the robot

and used to define the new visual datum reference tool center point [26]. This calibrates the offline programs and defines the distance and orientation of the tool, fixture [40], and peripheral.

The offline programming with the visual datum reference tool [10] on the fixture [40] enables the visual datum reference tool [10] to be touched up to the “real world position” of the fixture [40] relative to the robot. If the fixture [40] ever needs to be moved or is accidently bumped, simply touch up the visual datum reference tool [10] and the entire path shifts to accommodate.

The visual datum reference tool of the present invention [10] is compatible with robotic simulation packages, including but not limited to, “Robcad®” which is a registered trademark of Tecnomatix Technologies Ltd., “Delmia®” which is a registered trademark of Dassault Systemes, Roboguide® which is a registered trademark of Fanuc Ltd. Corp., and “RobotStudio®” which is a registered trademark of ABB AB Corp. CAD software.

The first and second laser beams [22 and 24] are projected onto known features of the robot tool [20], and then used to calibrate the path of the robot tool [20] and measure the relationship of the fixture [40] relative to the robot tool [20].

The CAD user initially selects a position best suited on a tool or work piece to avoid crashes with other tooling and for ease of access for the robot or end-of-arm tooling. The visual datum reference tool of the present invention [10] preferably mounts onto a fixture [40] using a standard NAAMS hole pattern mount [34]. The mounts are laser cut to ensure the exact matching of hole sizes for the mounting of parts.

The visual datum reference tool [10] has a zero point, a zero reference frame, and a zero theoretical frame in space, which is positioned on the fixture [40].

The visual datum reference tool [10] is placed onto the fixture [40], visually enabling the tool center point [26] of the weld gun to be orientated into the visual datum reference tool [10] obtaining the “real-world” relationship of the robot tool [20] to the fixture [40] while updating the visual datum reference tool [10] to this “real-world” position.

The visual datum reference tool of the present invention [10] requires that the position of the visual datum reference tool [10] correlate with the position of the robot tool [20] to calibrate the path of the robot tool [20] while acquiring the “real-world” distance and orientation of the fixture [40] relative to the robot tool [20].

The visual datum reference tool [10] calibration method positions the robot tool [20] with the calibration device and determines the difference.

The visual datum reference tool of the present invention [10] is used to calibrate a “known” calibration device or frame (robotic simulation CAD software provided calibration device). The robotic calibration method of the present invention works by projecting laser beams to a known X, Y, and Z position and defining known geometric planes used to adjust the roll, yaw, and pitch of the robot tool [20] relative to the tool center point [26].

The laser is projected onto the robotic end of the robot arm tooling (weld guns, material handlers, MIG torches, etc.) where the user will manipulate the robot with end-of-arm tooling into these lasers to obtain the positional difference between the “known” off-line program (simulation provided calibration device) and the actual (shop floor) calibration device. The reverse is also true—for instance; a material handler robot can carry the visual datum reference tool [10] to a known work piece with known features.

The CAD model of the visual datum reference tool [10] is placed in the robotic simulation CAD world. The CAD user selects a position best suited on a tool or work piece to avoid crashes with other tooling and for ease of access for the robot or end-of-arm tooling. The off-line programs are then downloaded relative to this visual datum reference tool [10]. The visual datum reference tool [10] will be placed onto the tool or work piece in the position that was defined by the CAD user on the shop floor. The robot technician then manipulates the tool center point [26] into the device, aligning it to the laser beams to obtain the difference between the CAD world and shop floor. This difference is then entered into the robot and used to define the new calibration device, thus calibrating the off-line programs and defining the distance and orientation of the tool, fixture [40], peripheral, and other key components.

The visual datum reference tool of the present invention [10] calibrates the paths to the robot while involving the calibration of the peripherals of the robot.

The visual datum reference tool of the present invention [10] aids in the kitting; or reverse engineering; of robotic systems for future use in conjunction with robotic simulation software; enabling integrators the ability to update their simulation CAD files to the “real world” positions.

The automatic work finder calibration system depicted in FIG. 1 is used in conjunction with the robotic work object cell calibration system described. The device is placed over the weld tips of a weld gun or pin on an end-of-arm-tooling (TCP Location). The device will have several LEDs aligned in the X, Y, and Z orientation of the TCP. The robot will search for the laser beams being emitted from the robotic work object cell calibration system and received into the automatic work finder calibration system. Once the emitted laser beam is found, the LEDs send feedback to the robot informing the robot that the robotic work object cell calibration system is aligned.

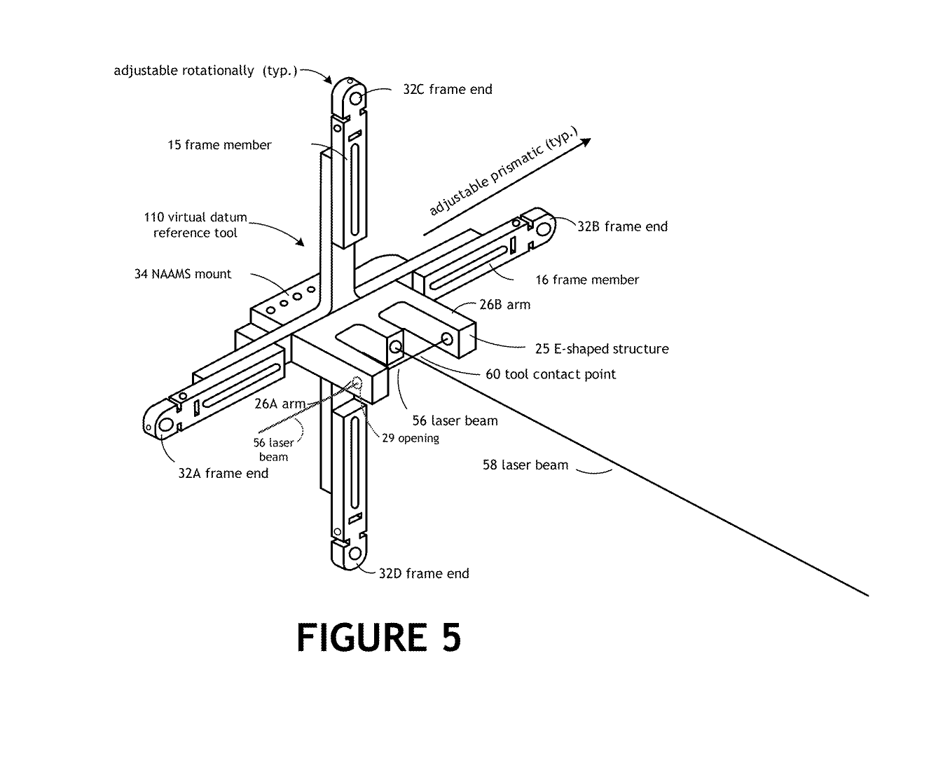

FIG. 5 depicts a second preferred embodiment of a visual datum reference tool [20]. An “E-shaped” structure is lays horizontally and is positioned at the center of a frame comprising a vertical frame crossing a horizontal frame.

The visual datum reference tool [20] is used to calibrate the work path of a robot tool based on a tool center point (point in space) [26]. The known point in space [26] is defined in three dimensions (X, Y, and Z) and relative to their rotational axes Rₓ (pitch), R_{y} (yaw), and R_{z} (roll).

The visual datum reference tool [20] includes a horizontal frame member [15] that includes a pair of opposing frame ends [32A and 32B], and a vertical frame member

that includes a pair of opposing frame ends [32C and 32D]. A plane-projecting laser [41, 42, 43, and 44] is preferably disposed at each frame end [32A, 32B, 32C, and 32D], respectively, and a projected laser plane (not shown) is emitted from each of the plane-projecting lasers [41, 42, 43, and 44], respectively.

Extending along the horizontal frame member [15] are three arms parallel which combine to form a squared “E-shaped” structure [25] which is horizontally aligned and generally centrally disposed relative to horizontal frame member [15] and vertical frame member [16]. The center arm (not numbered) of the E-shaped structure [25] is shorter than the two end arms [27A and 27B].

A first laser beam [22] is emitted from the shortened center arm of the “E-shaped” structure [25] disposed at the proximate center of the visual datum reference tool [20]. A second laser beam [24] is emitted from one of the arms [27B] of an E-shaped structure [25] and is directed into and through an opening 29 in the opposing arm [27A].

The first laser beam-[22] intersects the second laser beam [24] at the tool center point [26]. The first laser beam-[22] is essentially perpendicular and coplanar with the second laser beam [24], defined in three dimensions in terms of X, Y, and Z coordinates.

The “E-shaped” structure [25] is positioned at the center of the horizontal frame member [15] and the vertical frame member [16], laser beam [24] is essentially coplanar with the two projected laser planes (not shown) emitted from the plane-projecting lasers [41 and 42] emitted from frame ends [32A and 32B]. Similarly, laser beam [22] is essentially coplanar with the two projected laser planes (not shown) emitted from the plane-projecting lasers [43 and 44] emitted from frame ends [32C and 32D]. The visual datum reference tool [20] is mountable onto a fixture [70] and enables a robot work path to be calibrated relative to the known point in space [26].

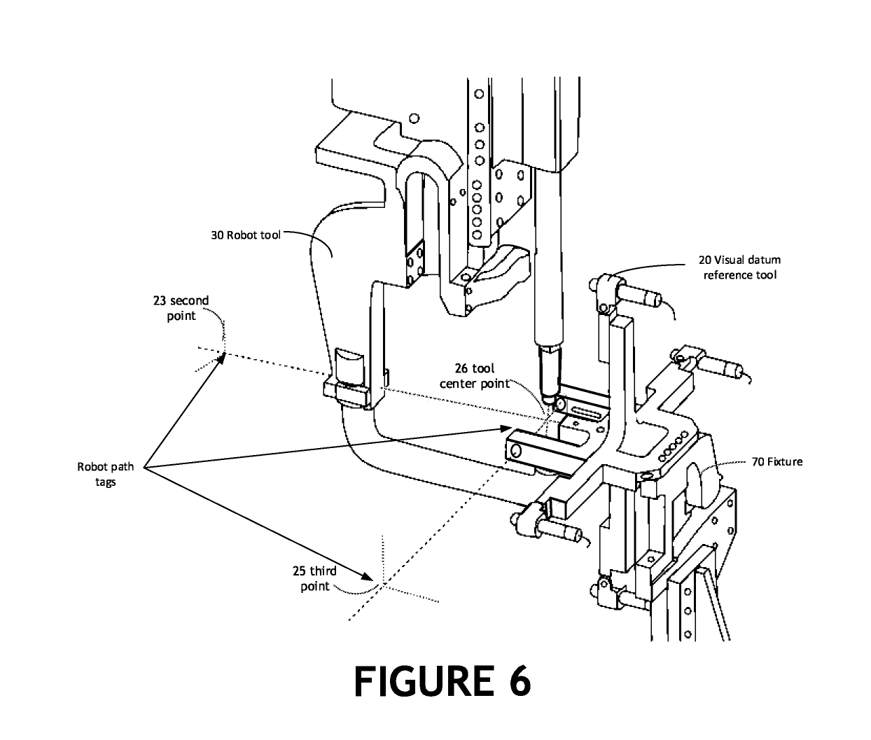

The plane-projecting lasers project the four projected laser planes (not shown) from the frame ends [32A, 32B, 32C, and 32D, respectively] of the visual datum reference tool [20]. The plane-projecting lasers (see FIG. 6) are preferably red laser modules, having focused lines (3.5 v-4.5 v 16 mm 5 mw).

The laser beams [22 and 24] are focusable points that project the two laser beams emitted from the arm [26B] of the visual datum reference tool [20]. The laser beams [56 and 58] are red laser modules, having focusable dots (3.5 v-4.5 v 16 mm 5 mw).

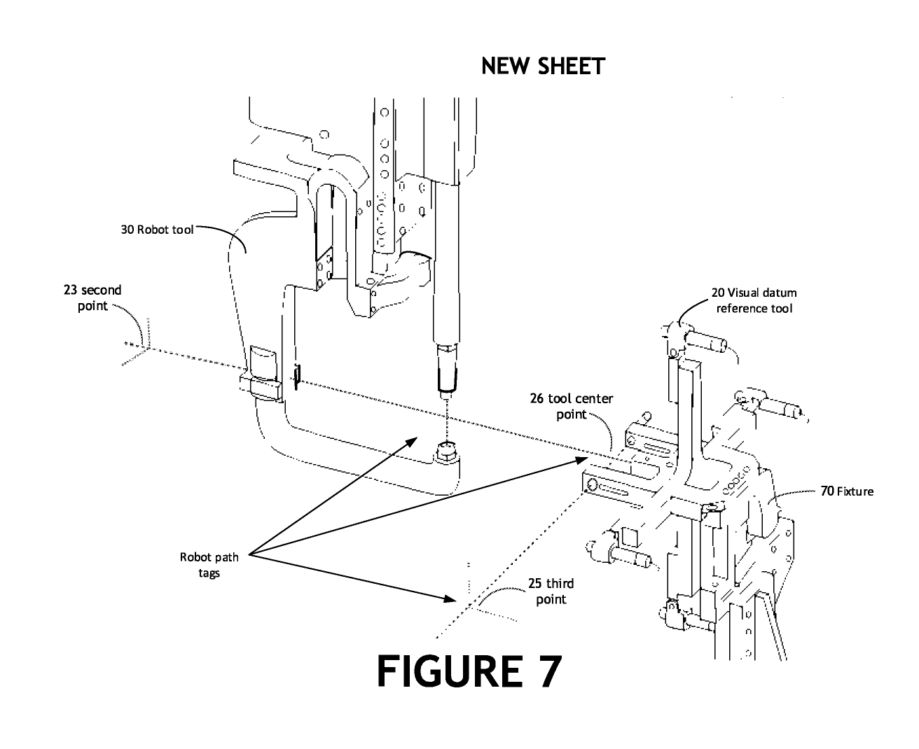

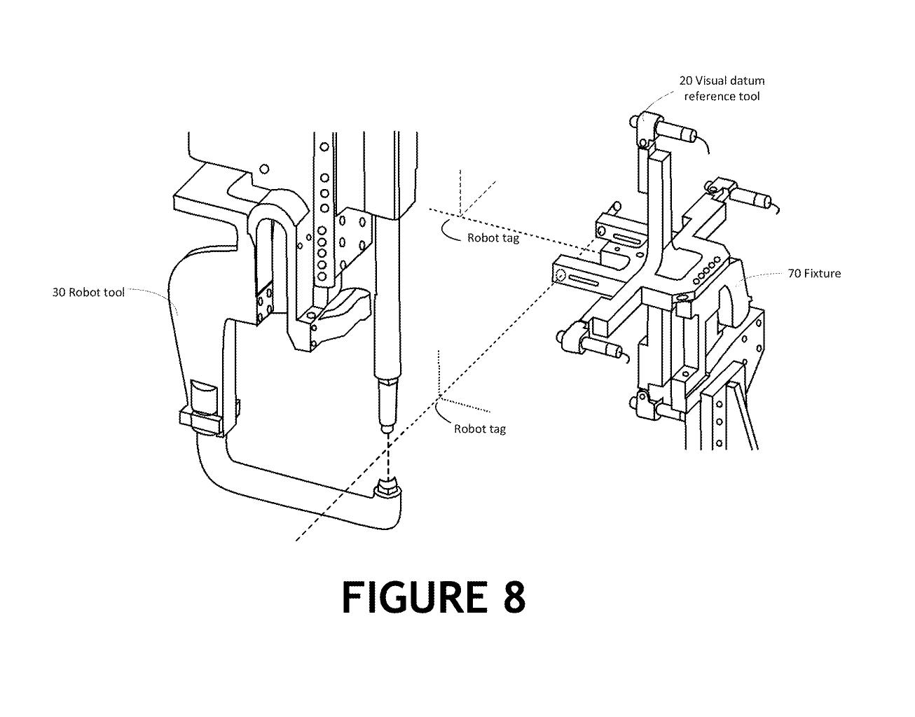

The visual datum reference tool of the present invention [20] includes two (2) laser beams positioned onto a work piece or tool, at a known location with the two laser beams [22 and 24] intersecting at essentially a 90° angle and continuing to project outward. The mounting is preferably a numerical control block or a NAAMS mounting pattern [34]. The tool center point [26] of the robot defines the correct location of the robotic reference frame [35]. To accomplish this, the robot will record a first point [26] at the intersection of the two (2) laser beams (see FIG. 5). A second point [23] is then selected along the axis of the first laser beam [22] (see FIG. 6). A third point [25] is then selected along the axis of the second laser beam [24] (see FIG. 7).

In other words, the robotic reference frame [35] is defined by the two intersecting laser beams [22 and 24]. Once all three (3) points [22, 24, and 26] are known, the robotic reference frame [35] is generated. The robotic reference frame is then used to adjust the angular position of the robot tool [20], which can involve adjusting either roll and yaw, roll and pitch, yaw and pitch, or roll yaw and pitch of said robot tool [20]. This method is applicable for all robotic processes, including but not limited to, spot welders, material handlers, and MIG welders, assembly, cutting, painting and coating, and polishing and finishing.

The robotic work object cell calibration tool [20] includes a horizontal frame member that includes a pair of opposing frame ends [32A and 32B], and a vertical frame member that includes a pair of opposing frame ends [32C and 32D]. A plane-projecting laser [41, 42, 43, and 44] is preferably disposed at each frame end [32A, 32B, 32C, and 32D], respectively, and a projected laser plane is emitted from each of the plane-projecting lasers [41, 42, 43, and 44], respectively.

Extending along the horizontal frame member are three arms parallel which combine to form the general shape of the letter “E” of an E-shaped structure [25] which is horizontally aligned and generally centrally disposed relative to frame member [15]. The center arm (not numbered) is shorter than the two end arms [26A and 26B].

A first beam-projecting laser [58] is emitted from the center arm of the “E” disposed at the proximate center of the robotic work object cell calibration tool [20]. A second beam-projecting laser [56] is emitted from one of the arms [26A] of an E-shaped structure [25] and is directed into the opposing arm [26B]. The robotic work object cell calibration tool [20] has been modified in that opposing arm [26B] now includes an opening [29], enabling second beam-projecting laser [56] to pass through unencumbered. The beam-projecting lasers [56 and 58] serve as a crosshair, intersecting at the tool center point (TCP).

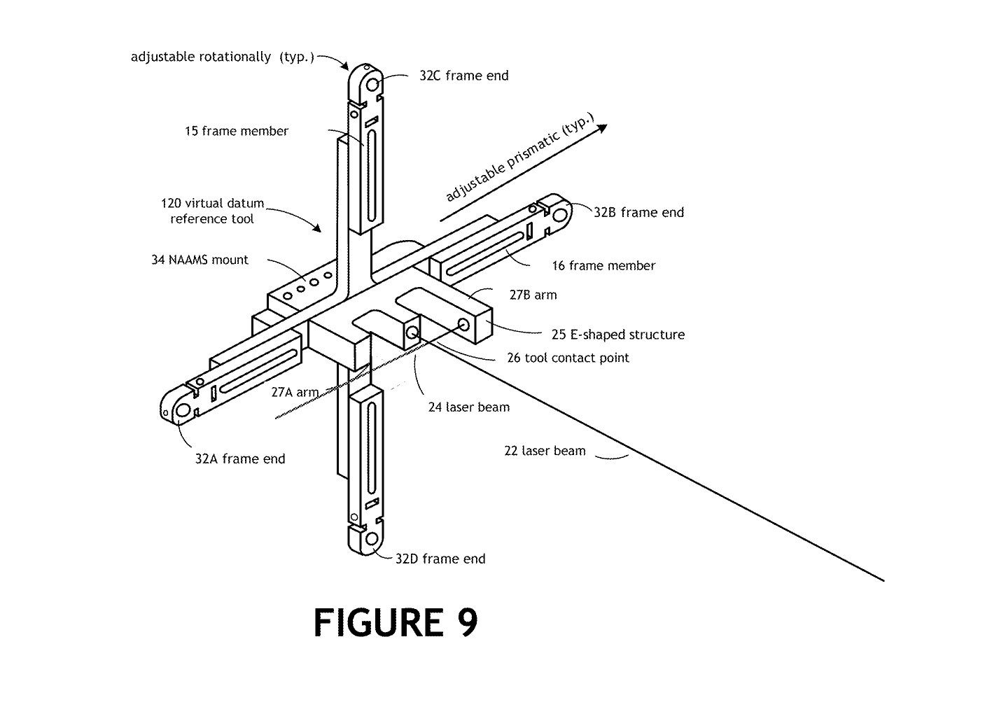

FIG. 9 depicts a perspective view of a third preferred embodiment of the visual datum reference tool for use with the manual and automatic robot work finder calibration systems and methods of the present invention, the visual datum reference tool [120] having two beam-projecting laser beams [22 and 24] being used for aligning the tool center point with a calibration device. In this embodiment, arm [27A] has been shortened enabling laser beam to extend beyond the visual datum reference tool, unimpeded.

The technology uses existing body-in-white procedures, personnel computers and software and ways of communicating information amongst the trades.

Throughout this application, various Patents/Applications are referenced by number and inventor. The disclosures of these Patents/Applications are hereby incorporated by reference into this specification in their entireties in order to more fully describe the state of the art to which this invention pertains.

It is evident that many alternatives, modifications, and variations of the visual datum reference tool and method of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10. visual datum reference tool
12. first laser
14. second laser
15 horizontal frame member
16 vertical frame members
18. wedge
20. visual datum reference tool
22. first laser beam
23. second point
24. second laser beam
25. third point
26. tool center point
27A and 27B. arms
28. robotic datum/frame
29. opening
32A, 32B, 32C, and 32D frame ends
34. NC block or NAAMS mount
35. robotic reference frame
38. robot
40. fixture
120. visual datum reference tool

1-16. (canceled)

17. A visual datum reference tool for calibrating a robotic work path relative to a robot tool using CAD means, said visual datum reference tool comprising:
a. a first laser mounted on said visual datum reference tool, said first laser projecting a first laser beam relative to said robot tool;
b. a second laser mounted on said visual datum reference tool, said second laser projecting a second laser beam relative to said robot tool, said second laser beam intersecting said first laser beam at a laser beam intersection point relative to said robot tool;
c. a robotic reference frame defined by a first point disposed at said laser beam intersection point, a second point disposed along said first laser beam other than at said laser beam intersection point relative to said robot tool, and a third point disposed along said second laser beam other than said laser beam intersection point relative to said robot tool, calibration of said robotic work path deploying said robotic reference frame using CAD simulation software;
wherein said first and second laser beams intersect at a 90° angle.

18. The visual datum reference tool of claim 17, whereby said visual datum reference tool is mounted onto a fixture using a numerical control block.

19. The visual datum reference tool of claim 17, further comprising said visual datum reference tool is mounted onto a NAAMS mounting pattern.

20. The visual datum reference tool of claim 17, whereby roll, pitch, and yaw are adjustable once said robotic work path has been calibrated.

21. A method for calibrating a robotic work path relative to a robot tool deploying a visual datum reference tool using CAD means, a first and a second laser being mounted on said visual datum reference tool, said first laser projecting a first laser beam relative to said robot tool, said second laser projecting a second laser beam relative to said robot tool, said first laser beam intersecting said second laser beam at a laser beam intersection point, said calibration method comprising:
a. securely mounting said visual datum reference tool;
b. identifying a first reference point, said first reference point being disposed at said laser beam intersection point;
c. identifying a second reference point along said first laser beam, said second reference point being disposed at a position other than at said laser beam intersection point relative to said robot tool;
d. identifying a third reference point along said second laser beam, said third reference point being disposed at a position other than at said laser beam intersection point relative to said robot tool; and
e. generating a robotic reference frame that includes said first, second, and third reference points; and
f. calibrating said work path of said robot tool based upon said robotic reference frame with CAD simulation software, angular positions being adjustable once said robotic work path has been calibrated.

22. The method of claim 21, whereby said first and second laser beams intersect at a 90° angle.

23. The method of claim 21, whereby said visual datum reference tool is mounted onto a fixture using a numerical control block or onto a NAAMS mounting pattern.

24. A method for calibrating a robotic work path relative to a robot tool deploying a visual datum reference tool using CAD means, a first and second laser beam being mounted on said visual datum reference tool, said first last projecting a first laser beam relative to said robot tool, said second last projecting a second laser beam relative to said robot tool, said first laser beam intersecting said second laser beam at a laser beam intersection point, said calibration method comprising:
a. securely mounting said visual datum reference tool;
b. generating a robotic reference frame, said robotic reference frame being defined by a plane formed by said first and second laser beams; and
c. calibrating said work path of said robot tool based upon said robotic reference frame with CAD simulation software, angular positions being adjustable once said robotic work path has been calibrated.

25. The method of claim 24, whereby said first and second laser beams intersect at a 90° angle.

26. The method of claim 24, whereby said visual datum reference tool is mounted onto a fixture using a numerical control block or onto a NAAMS mounting pattern.

27. A visual datum reference tool for calibrating a robotic work path relative to a robot tool using CAD means, said visual datum reference tool comprising:
a. a first laser mounted on said visual datum reference tool, said first last projecting a first laser beam relative to said robot tool;
b. a second laser mounted on said visual datum reference tool, said second laser projecting a second laser beam relative to said robot tool, said second laser beam intersecting said first laser beam at a laser beam intersection point;
c. a robotic reference frame defined by a first point disposed at said laser beam intersection point, a second point disposed along said first laser beam other than at said laser beam intersection point relative to said robot tool, and a third point disposed along said second laser beam other than said laser beam intersection point relative to said robot tool, calibration of said work path of said robot tool deploying said robotic reference frame using CAD simulation software.

28. The visual datum reference tool of claim 27, whereby said first and second laser beams intersect at a 90° angle.

29. The visual datum reference tool of claim 27, whereby said visual datum reference tool is mounted onto a fixture using a numerical control block or onto a NAAMS mounting pattern.

30. A method for calibrating a robotic work path deploying a visual datum reference tool, a first and a second laser being mounted on said visual datum reference tool, said first laser emitting a first laser beam, said second laser emitting a second laser beam, said first laser beam intersecting said second laser beam at a laser beam intersection point, said calibration method comprising:
a. mounting said visual datum reference tool at a secure position relative to said robot tool; and
b. generating a robotic reference frame, said robotic reference frame being defined by a plane formed by a first point disposed at said laser beam intersection point relative to said robot tool, a second point disposed along said first laser beam other than at said laser beam intersection point relative to said robot tool, and a third point disposed along said second laser beam other than said laser beam intersection point relative to said robot tool; and
c. using said robotic reference frame to calibrate said work path of said robot tool based with CAD simulation software.

31. The method of claim 29, whereby said first and second laser beams intersect at a 90° angle.

32. A visual datum reference tool system for calibrating a robotic work path relative to a robot tool using CAD means, said system comprising:
a. a robot tool having angular positions that are adjustable; and
b. a visual datum reference tool, a first and a second laser being mounted on said visual datum reference tool, said first laser emitting a first laser beam, said second laser emitting a second laser beam, said first laser beam intersecting said second laser beam at a laser beam intersection point, said visual datum reference tool having a robotic reference frame, said robotic reference frame being defined by a first point disposed at said laser beam intersection point, a second point disposed along said first laser beam other than at said laser beam intersection point, and a third point disposed along said second laser beam other than said laser beam intersection point, said visual datum reference tool being mountable onto a fixture, calibration of said work path of said robot tool deploying said robotic reference frame using CAD simulation software.

33. The visual datum reference system of claim 31, whereby said first and second laser beams intersect at a 90° angle.

34. The visual datum reference system of claim 31, whereby said visual datum reference tool is mounted onto a fixture using a numerical control block.

35. The visual datum reference system of claim 31, further comprising said visual datum reference tool is mounted onto a NAAMS mounting pattern.

36. The visual datum reference system of claim 31, whereby said first laser beam and said second laser beam serve as crosshairs intersecting at a laser beam intersection point.
